(19) United States
(12) Patent Application Publication
(10) Pub. No.: US 2022/0147868 A1
(43) Pub. Date: May 12, 2022

(54) ADJUSTING METHOD AND TRAINING SYSTEM OF MACHINE LEARNING CLASSIFICATION MODEL AND USER INTERFACE

(71) Applicant: INDUSTRIAL TECHNOLOGY RESEARCH INSTITUTE, Hsinchu (TW)

(72) Inventors: Hsin-Cheng LIN, Hemei Township (TW); Sen-Yih CHOU, Hsinchu City (TW)

(73) Assignee: INDUSTRIAL TECHNOLOGY RESEARCH INSTITUTE, HSINCHU (TW)

(21) Appl. No.: 17/115,266

(22) Filed: Dec. 8, 2020

(30) Foreign Application Priority Data
Nov. 9, 2020 (TW) 109138987

(51) Int. Cl. G06N 20/00; G06K 9/62

(52) U.S. Cl. CPC G06N 20/00; G06K 9/6267

(57) ABSTRACT

An adjusting method and a training system for a machine learning classification model and a user interface are provided. The machine learning classification model is used to identify several categories. The adjusting method includes the following steps. Several identification data are inputted to the machine learning classification model to obtain several confidences of the categories for each of the identification data. A classification confidence distribution for each of the identification data whose highest value of the confidences is not greater than a critical value is recorded. The classification confidence distributions of the identification data are counted. Some of the identification data are collected according to the cumulative counts of the classification confidence distributions. Whether the collected identification data belong to a new category is determined. If the collected identification data belong to a new category, the new category is added.

This application claims the benefit of Taiwan application Serial No. 109138987, filed Nov. 9, 2020, the disclosure of which is incorporated by reference herein in its entirety.

### TECHNICAL FIELD

The disclosure relates in general to an adjusting method and a training system for a machine learning classification model and a user interface.

### BACKGROUND

In the object detection or category classification of the machine learning classification model, it is possible that classification errors or low classification confidence may occur. If the features of the identified object are seldom included in the training data, identification correctness may become too low. Or, if the identification breadth of the machine learning classification model is too narrow and the identified object has never been seen before, the identified object may be wrongly classified to an incorrect category and result in an identification error.

The most commonly used method for resolving the above problems is to increase the size of the original training data. However, the said method, despite consuming a large amount of time and labor, can only make little improvement.

### SUMMARY

The disclosure is directed to an adjusting method and a training system for a machine learning classification model and a user interface.

According to one embodiment, an adjusting method for a machine learning classification model is provided. The machine learning classification model is used to identify several categories. The adjusting method includes the following steps. Several identification data are inputted to the machine learning classification model to obtain several confidences of the categories for each of the identification data. A classification confidence distribution for each of the identification data whose highest value of the confidences is not greater than a critical value is recorded. The classification confidence distributions of the identification data are counted. Some of the identification data are collected according to the cumulative counts of the classification confidence distributions. Whether the collected identification data belong to a new category is determined. If the collected identification data belong to a new category, the new category is added.

According to another embodiment, a training system for a machine learning classification model is provided. The machine learning classification model is used to identify several categories. The training system includes an input unit, a machine learning classification model, a recording unit, a statistical unit, a collection unit, a determination unit and a category addition unit. The input unit is configured to input several identification data. The machine learning classification model is configured to obtain several confidences of the categories for each of the identification data. The recording unit is configured to record a classification confidence distribution for each of the identification data whose highest value of the confidences is not greater than a critical value. The statistical unit is configured to count the classification confidence distributions of the identification data. The collection unit is configured to collect some of the identification data according to the cumulative counts of the classification confidence distributions. The determination unit is configured to determine whether the collected identification data belong to a new category. If the collected identification data belong to the new category, the category addition unit adds the new category.

According to an alternative embodiment, a user interface for a user to operate a training system for a machine learning classification model is provided. The machine learning classification model is used to identify several categories. After the machine learning classification model receives several identification data, the machine learning classification model obtains several confidences of the categories for each of the identification data. The user interface includes a recommendation window, a classification confidence distribution window and a classification confidence distribution window. The recommendation window is configured to show several optimized recommendation data sets. When one of the optimized recommendation data sets is clicked, the classification confidence distribution window shows a classification confidence distribution of the optimized recommendation data set which is clicked.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a training system for a machine learning classification model according to an embodiment.

FIG. 2 is a flowchart of an adjusting method for a machine learning classification model according to an embodiment.

FIG. 3 is a schematic diagram of a user interface according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

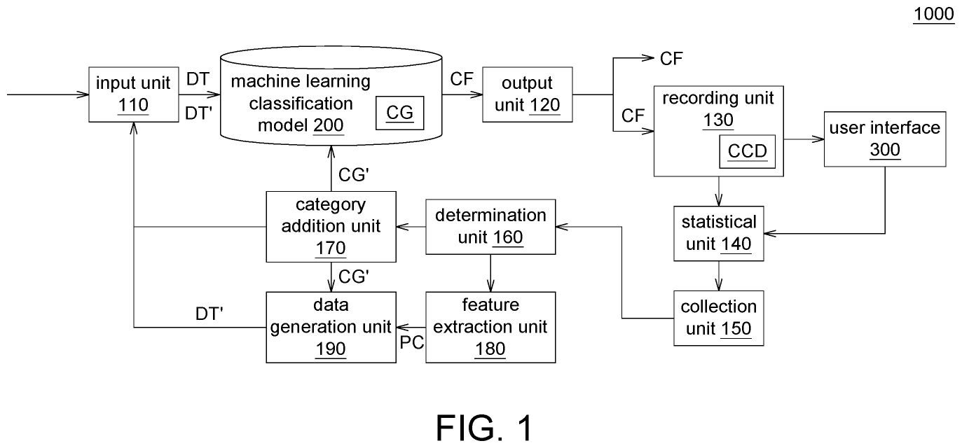

Referring to FIG. 1, a schematic diagram of a training system 1000 for a machine learning classification model 200 according to an embodiment is shown. The machine learning classification model 200 is used to identify several categories. For example, during the semiconductor process, the machine learning classification model 200 identifies “scratch”, “crack” “and circuit” on a wafer image. After a wafer image is inputted to the machine learning classification model 200, several identification values are obtained and listed in Table 1. Since the confidence of the “scratch” category being the highest among all confidences is higher than a predetermined value (such as 80%), an identification result being “scratch” is outputted.

TABLE 1

| Category | Confidence |
|---|---|
| Scratch | 92% |
| Crack | 5% |
| Circuit | 2% |

In another example, after a wafer image is inputted to the machine learning classification model 200, several identification values are obtained and listed in Table 2. Since the confidence of the “crack” category being the highest among all confidences is still not higher than a predetermined value (such as 80%), no identification result is outputted. Unlike the training data of the machine learning classification model 200 in which cracks always occur at the edge, the present wafer image has cracks at the central position and is unable to produce a high confidence for the “crack” category. The training system 1000 of the present disclosure can generate new data and train the machine learning classification model 200 using the generated data to optimize the identification result.

TABLE 2

| Category | Confidence |
|---|---|
| Scratch | 6% |
| Crack | 72% |
| Circuit | 3% |

In another example, after a wafer image is inputted to the machine learning classification model 200, several identification values are obtained and listed in Table 3. Although the confidence of the “scratch” category has little difference in comparison to the “crack” category, they are not higher than the predetermined value (such as 80%), and no identification result can be outputted. The confidence of the “circuit” category is also extremely low. It is possible that the machine learning classification model 200 does not have enough categories (for example, the machine learning classification model 200 should include a “micro-particle” category), so no category can produce a high confidence. The training system 1000 of the present disclosure can add a new category for the identification data and train the machine learning classification model 200 using the new category to optimize the identification result.

TABLE 3

| Category | Confidence |
|---|---|
| Scratch | 32% |
| Crack | 35% |
| Circuit | 3% |

Refer to FIG. 1. The training system 1000 of the machine learning classification model 200 includes an input unit 110, a machine learning classification model 200, an output unit 120, a recording unit 130, a statistical unit 140, a collection unit 150, a determination unit 160, a category addition unit 170, a feature extraction unit 180, a data generation unit 190 and a user interface 300. The functions of those elements are briefly disclosed below. The input unit 110, such as a transmission line, a transmission module, a hard disc, a memory or a cloud data center, is configured to input data. The output unit 120, such as a transmission line, a transmission module or a display, is configured to output an identification result. The recording unit 130, such as a memory, a hard disc or a cloud data center, is configured to record data. The statistical unit 140 is configured to count data. The collection unit 150 is configured to collect the data. The determination unit 160 is configured to perform a determination process. The category addition unit 170 is configured to add a new category. The feature extraction unit 180 is configured to extract features. The data generation unit 190 is configured to generate data. The statistical unit 140, the collection unit 150, the determination unit 160, the category addition unit 170, the feature extraction unit 180, and the data generation unit 190 can be realized by a circuit, a chip, a circuit board, a programming code or a storage storing programming codes. The user interface 300 can be realized by a display panel of a mobile device.

The training system 1000 can supplementarily train the machine learning classification model 200 using the feature extraction unit 180 and the data generation unit 190 to improve the situation of Table 2. Moreover, the training system 1000 can supplementarily train the machine learning classification model 200 using the category addition unit 170 to improve the situation of Table 3. The operations of the above elements are disclosed below with a flowchart.

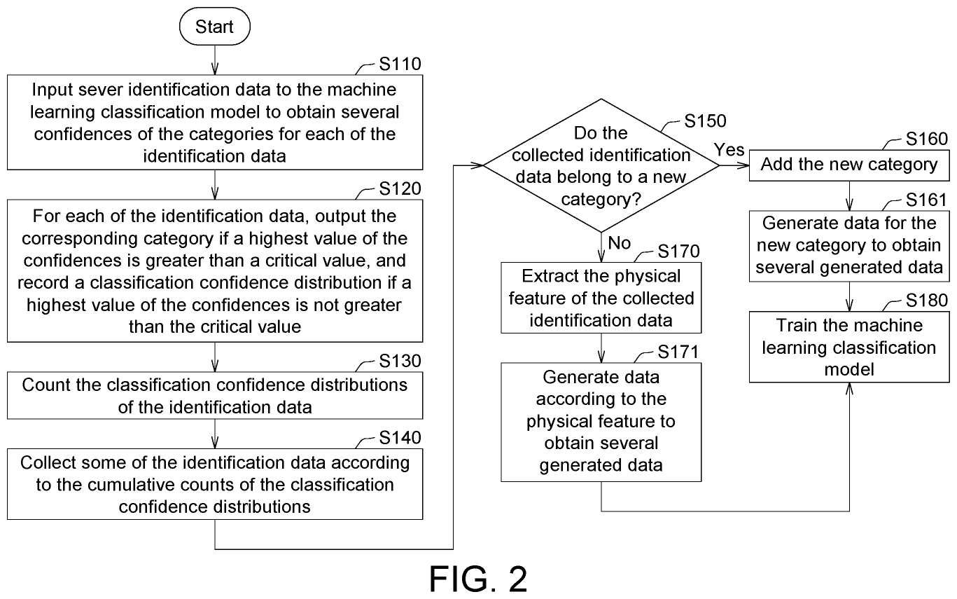

Referring to FIG. 2, a flowchart of an adjusting method for the machine learning classification model 200 according to an embodiment is shown. The machine learning classification model 200 is used to identify several categories CG. In step S110, several identification data DT are inputted to the machine learning classification model 200 by the input unit 110 to obtain several confidences CF of the categories CG for each of the identification data DT. One confidence CF of each of the categories CG can be obtained for each of the identification data DT. The category CG with the highest value of the confidences CF represents the most likely category of the identification data DT.

Then, the method proceeds to step S120, for each of the identification data DT, if the highest value of the confidences CF is greater than a critical value (such as 80%), a corresponding category CG is outputted by the output unit 120; if the highest value of the confidences CF is not greater than a critical value, a classification confidence distribution CCD of the confidences CF is recorded by the recording unit 130.

Referring to Table 4, a classification confidence distribution CCD for an identification data DT is listed. Several confidence intervals, such as 80% to 70%, 70% to 60%, 60% to 50%, 50% to 40%, 40% to 30%, 30% to 20%, 20% to 10%, 10% to 0%, can be pre-determined for each of the categories CG (for example, none of the above confidence intervals includes an upper limit). It should be noted that none of the confidence interval includes a range greater than the critical value. The classification confidence distribution CCD of Table 4 is a combination of the “the scratch category has a confidence interval of 40% to 30%”, “the crack category has a confidence interval of 40% to 30%” and “the circuit category has a confidence interval of 10% to 0%”.

TABLE 4

| | | Confidence |
|---|---|---|
| Category | Confidence | Interval |
| Scratch | 32% | 40% to 30% |
| Crack | 35% | 40% to 30% |
| circuit | 3% | 10% to 0% |

Referring to Table 5, a classification confidence distribution CCD for another identification data DT is listed. The classification confidence distribution CCD of Table 5 is a combination of the “the scratch category has a confidence interval of 60% to 50%”, “the crack category has a confidence interval of 40% to 30%” and “the circuit category has a confidence interval of 10% to 0%”. The classification confidence distribution CCD of Table 5 is different from that of Table 4.

TABLE 5

| | | Confidence |
|---|---|---|
| Category | Confidence | Interval |
| Scratch | 66% | 60% to 50% |
| Crack | 39% | 40% to 30% |
| Circuit | 9% | 10% to 0% |

Referring to Table 6, a classification confidence distribution CCD for another identification data DT is listed. The classification confidence distribution CCD of Table 6 is a combination of the “the scratch category has a confidence interval of 40% to 30%”, “the crack category has a confidence interval of 40% to 30%” and “the circuit category has a confidence interval of 10% to 0%”. The confidences CF of Table 6 are different from that of Table 4, but the classification confidence distribution CCD of Table 6 is identical to that of Table 4.

TABLE 6

| | | Confidence |
|---|---|---|
| Category | Confidence | Interval |
| Scratch | 31% | 40% to 30% |
| Crack | 32% | 40% to 30% |
| Circuit | 5% | 10% to 0% |

As the machine learning classification model 200 continues to identify the identification data DT, more and more classification confidence distributions CCD will be recorded, wherein some of the recorded classification confidence distributions CCD are identical.

Then, the method proceeds to step S130, the classification confidence distributions CCD of the identification data DT are counted by the statistical unit 140. In the present step, various classification confidence distributions CCD are accumulated by the statistical unit 140, and the cumulative counts are shown on the user interface 300 for recommendation.

Then, the method proceeds to step S140, some of the identification data DT are collected by the collection unit 150 according to the cumulative counts of the classification confidence distributions CCD. The collection unit 150 collects the identification data DT corresponding to the highest cumulative count of the classification confidence distributions CCD. For example, if the highest cumulative count of the classification confidence distribution CCD is 13, this implies that there are 13 items of identification data DT corresponding to the classification confidence distributions CCD, and the collection unit 150 collects the 13 items of identification data DT.

Then, the method proceeds to step S150, whether the collected identification data DT belong to a new category is determined by the determination unit 160. The new category refers to a category not included in the categories CG defined by the machine learning classification model 200. For example, the determination unit 160 can automatically make determination using an algorithm, such as k-means algorithm. Or, the determination unit 160 can receive an inputted message from an operator to confirm whether the identification data DT belong to a new category. If the collected identification data DT belong to a new category (not included in the defined categories CG), the method proceeds to step S160; if the collected identification data DT do not belong to a new category (but belong to one of the defined categories CG), the method proceeds to step S170.

In step S160, a new category, such as “micro-particle” category CG′, is added by the category addition unit 170.

Then, the method proceeds to step S161, data are generated for the new category CG′ by the data generation unit 190 to obtain several generated data DT′. The data generation unit 190 generates data using such as a generative adversarial network (GAN) algorithm or a domain randomization algorithm. In the present step, data are generated for the new category CG′, such as a dummy “micro-particle” category, to obtain several generated data DT′.

Then, the method proceeds to step S180, the generated data DT′ are inputted to the machine learning classification model 200 with the new category by the input unit 110 to train the machine learning classification model 200. Thus, the features of the machine learning classification model 200 can be modified, such that the modified machine learning classification model 200 can correctly identify the new category CG′.

In an embodiment, the step S170 can be omitted, and the existing identification data DT are directly identified and trained by the machine learning classification model 200 according to the existing category CG and the new category CG′. Thus, the features of the machine learning classification model 200 can be modified, such that the modified machine learning classification model 200 can correctly identify the new category CG′.

In step S170, at least one physical feature PC of the collected identification data DT is extracted by the feature extraction unit 180. All of the collected identification data DT belong to the defined category CG but are not correctly identified. Thus, the training data still have some drawbacks and need to be improved. Most of the existing identification data DT are cracks or notches at the edge, but the 13 items of identification data DT collected by the collection unit 150 are cracks at the central position of the wafer and are not correctly classified as the “crack” category CG by the machine learning classification model 200.

Then, the method proceeds to step S171, data are generated by the data generation unit 190 according to the physical feature PC to obtain several generated data DT′. The generated data have similar physical feature PC to enhance the existing identification data DT. For example, the data generation unit 190 can generate some generated data DT′ having cracks at the central position and pre-mark the positions of the cracks.

Then, the method proceeds to step S180, the generated data DT′ are inputted to the machine learning classification model 200 by the input unit 110 to train the machine learning classification model 200. Thus, the features of the machine learning classification model 200 can be modified, such that the corrected machine learning classification model 200 can correctly identify the identification data DT whose cracks are at the central positions of the wafer.

In step S171, the quantity of the generated data DT′ is relevant to the classification confidence distribution CCD lest the quantity of the generated data DT′ might be too large and affect the correctness of the machine learning classification model 200 or the quantity of the generated data DT′ might be too small and cannot enhance the correctness.

For example, the quantity of the generated data DT′ is negatively relevant with the highest confidence of classification confidence distribution CCD. That is, to produce a desired effect, the larger the value of the highest confidence, the smaller the required quantity of the generated data DT′; the smaller the value of the highest confidence, the larger the required quantity of the generated data DT′.

In an embodiment, the quantity of the generated data DT′ can be arranged as follows. When the highest confidence is greater than or equal to 60% and is less than 80%, the quantity of the generated data DT′ is 10% of the identification data DT; when the highest confidence is greater than or equal to 40% and is less than 60%, the quantity of the generated data DT′ is 15% of the identification data DT; when the highest confidence is greater than or equal to 20% and is less than 40%, the quantity of the generated data DT′ is 20% of the identification data DT; when the highest confidence is less than 20%, the quantity of the generated data DT′ is 25% of the identification data DT.

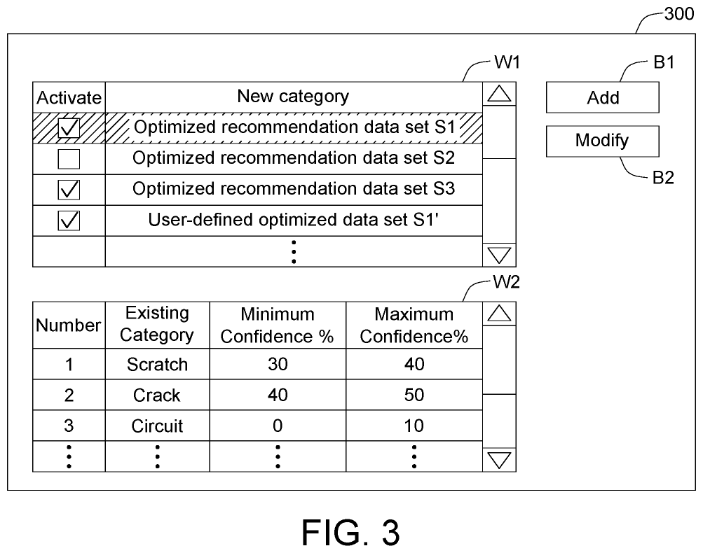

Besides, in step S130, the cumulative counts are shown on the user interface 300 for recommendation. An example of the user interface 300 is disclosed below. Referring to FIG. 3, a schematic diagram of a user interface 300 according to an embodiment is shown. The user interface 300 includes a recommendation window W1, a classification confidence distribution window W2, a set addition button B1 and a classification confidence distribution modifying button B2. The recommendation window W1 is configured to show several optimized recommendation data sets S1, S2, S3, . . . , etc. The identification data DT of the optimized recommendation data set S1 have identical classification confidence distribution CCD. The identification data DT of the optimized recommendation data set S2 have identical classification confidence distribution CCD. The identification data DT of the optimized recommendation data set S3 have identical classification confidence distribution CCD. When the user clicks the optimized recommendation data set S1, the classification confidence distribution window W2 will show the classification confidence distribution CCD of the identification data DT of the optimized recommendation data set S1.

The optimized recommendation data set S1, S2, S3, . . . , etc. are sorted according to a descending order of the cumulative counts of the classification confidence distributions CCD.

The set addition button B1 is configured to add a user-defined optimized data set S1′. The classification confidence distribution modifying button B2 is configured to modify the classification confidence distribution CCD of the user-defined optimized data set S1′. That is, in addition to the optimized recommendation data set S1, S2, S3, . . . , etc. which are recommended according to the cumulative counts of the classification confidence distributions CCD, the user can define the contents of the classification confidence distribution CCD to generate a user-defined optimized data set S1′ and obtain a corresponding identification data DT.

The user can tick one or more optimized recommendation data sets S1, S2, S3, . . . , etc. or the user-defined optimized data set S1′ to determine which of the identification data DT are used for subsequent data generation.

According to the above embodiments, the training system 1000 and the adjusting method for the machine learning classification model 200 can supplementarily train the machine learning classification model 200 using the feature extraction unit 180 and the data generation unit 190 to increase the correctness of identification. Moreover, the training system 1000 and the adjusting method can supplementarily train the machine learning classification model 200 using the category addition unit 170 to increase the breadth of identification.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An adjusting method for a machine learning classification model, wherein the machine learning classification model is used to identify a plurality of categories, and the adjusting method comprises:
inputting a plurality of identification data to the machine learning classification model to obtain a plurality of confidences of the categories for each of the identification data;
recording a classification confidence distribution for each of the identification data whose highest value of the confidences is not greater than a critical value;
counting the classification confidence distributions of the identification data;
collecting some of the identification data according to cumulative counts of the classification confidence distributions;
determining whether the collected identification data belong to a new category; and
adding the new category if the collected identification data belong to the new category.

2. The adjusting method for the machine learning classification model according to claim 1, wherein after the new category is added, the adjusting method further comprises:
inputting the identification data to the machine learning classification model with the new category to train the machine learning classification model.

3. The adjusting method for the machine learning classification model according to claim 1, wherein after the new category is added, the adjusting method further comprises:
generating data for the new category to obtain a plurality of generated data; and
inputting the generated data to the machine learning classification model with the new category to train the machine learning classification model.

4. The adjusting method for the machine learning classification model according to claim 1, further comprising:
extracting at least one physical feature of the collected identification data if the collected identification data do not belong to the new category;
generating data to obtain a plurality of generated data according to the at least one physical feature; and
inputting the generated data to the machine learning classification model to train the machine learning classification model.

5. The adjusting method for the machine learning classification model according to claim 4, wherein in the step of generating data, quantity of the generated data is relevant to the classification confidence distribution.

6. The adjusting method for the machine learning classification model according to claim 5, wherein in the step of generating data, the quantity of the generated data is negatively relevant to a highest confidence of the classification confidence distribution.

7. The adjusting method for the machine learning classification model according to claim 6, wherein in the step of generating data,
when the highest confidence is greater than or equal to 60% and is less than 80%, the quantity of the generated data is 10% of the identification data;
when the highest confidence is greater than or equal to 40% and is less than 60%, the quantity of the generated data is 15% of the identification data;
when the highest confidence is greater than or equal to 20% and is less than 40%, the quantity of the generated data is 20% of the identification data;
when the highest confidence is less than 20%, the quantity of the generated data is 25% of the identification data.

8. The adjusting method for the machine learning classification model according to claim 6, wherein the cumulative counts are shown on a user interface.

9. A training system for a machine learning classification model, wherein the machine learning classification model is used to identify a plurality of categories, and the training system comprises:
an input unit configured to input a plurality of identification data;
the machine learning classification model configured to obtain a plurality of confidences of the categories for each of the identification data;
a recording unit configured to record a classification confidence distribution for each of the identification data whose highest value of the confidences is not greater than a critical value;
a statistical unit configured to count the classification confidence distributions of the identification data;
a collection unit configured to collect some of the identification data according to cumulative counts of the classification confidence distributions;
a determination unit configured to determine whether the collected identification data belong to a new category; and
a category addition unit configured to add a new category if the collected identification data belong to the new category.

10. The training system for the machine learning classification model according to claim 9, wherein after the new category is added, the input unit further inputs the identification data to the machine learning classification model with the new category to train the machine learning classification model.

11. The training system for the machine learning classification model according to claim 9, further comprising:
a data generation unit configured to generate data to obtain a plurality of generated data after the new category is added;
wherein the input unit inputs the generated data to the machine learning classification model with the new category to train the machine learning classification model.

12. The training system for the machine learning classification model according to claim 9, further comprising:
a feature extraction unit configured to extract at least one physical feature of the collected identification data if the collected identification data do not belong to the new category; and
a data generation unit configured to generate data to obtain a plurality of generated data according to the at least one physical feature;
wherein the input unit further inputs the generated data to the machine learning classification model to train the machine learning classification model.

13. The training system for the machine learning classification model according to claim 12, wherein quantity of the generated data is relevant to the classification confidence distribution.

14. The training system for the machine learning classification model according to claim 13, wherein the quantity of the generated data is negatively relevant to a highest confidence of the classification confidence distribution.

15. The training system for the machine learning classification model according to claim 14, wherein
when the highest confidence is greater than or equal to 60% and is less than 80%, the quantity of the generated data is 10% of the identification data;
when the highest confidence is greater than or equal to 40% and is less than 60%, the quantity of the generated data is 15% of the identification data;
when the highest confidence is greater than or equal to 20% and is less than 40%, the quantity of the generated data is 20% of the identification data;
when the highest confidence is less than 20%, the quantity of the generated data is 25% of the identification data.

16. The training system for the machine learning classification model according to claim 9, further comprising:
a user interface used to show the cumulative counts.

17. A user interface for a user to operate a training system for a machine learning classification model, wherein the machine learning classification model is used to identify a plurality of categories, after the machine learning classification model receives a plurality of identification data, the machine learning classification model obtains a plurality of confidences of the categories for each of the identification data, and the user interface comprises:
a recommendation window configured to show a plurality of optimized recommendation data sets; and
a classification confidence distribution window, wherein when one of the optimized recommendation data sets is clicked, the classification confidence distribution window shows a classification confidence distribution of the optimized recommendation data set which is clicked.

18. The user interface according to claim 17, further comprising:
a set addition button configured to add a user-defined optimized data set.

19. The user interface according to claim 17, further comprising:
a classification confidence distribution modifying button used to modify a classification confidence distribution of the user-defined optimized data set.

20. The user interface according to claim 17, wherein the recommendation window is sorted according to cumulative counts of the classification confidence distributions for the optimized recommendation data sets.
